(19) United States
(12) Patent Application Publication
(10) Pub. No.: US 2026/0187136 A1
(43) Pub. Date: Jul. 2, 2026

(54) Methods, Systems, and Devices for Matching Multiple Versions of Media Content

(71) Applicant: The Nielsen Company (US), LLC, New York, NY (US)

(72) Inventors: Daniel John Nelson, Land O' Lakes, FL (US); John David Turbessi, Land O' Lakes, FL (US)

(21) Appl. No.: 19/040,507

(22) Filed: Jan. 29, 2025

Related U.S. Application Data
(60) Provisional application No. 63/739,200, filed on Dec. 27, 2024.

(51) Int. Cl. G06F 16/435; G06F 16/487

(52) U.S. Cl. CPC G06F 16/435; G06F 16/487

(57) ABSTRACT

An example method includes: (a) receiving a set of query fingerprints associated with a media file; (b) comparing the set of query fingerprints to a set of reference fingerprints associated with primary reference media files; (c) identifying first and second subsets of query fingerprints, wherein the first subset of query fingerprints satisfies a first threshold extent of similarity, and wherein the second subset of query fingerprints does not; (d) identifying at least one candidate reference media file of the primary reference media files; (e) comparing the second subset of query fingerprints to a subset of secondary reference fingerprints, wherein the subset of secondary reference fingerprints is based on the identified at least one candidate reference media file; (f) identifying a particular reference media file of the plurality of secondary reference media files; and (g) transmitting an indication that the media file matches the particular reference media file.

### CROSS-REFERENCE TO RELATED APPLICATIONS

This application is a non-provisional of, and claims priority to, U.S. Provisional Pat. App. No. 63/739,200 filed Dec. 27, 2024, which is hereby incorporated by reference herein in its entirety.

### SUMMARY

In one aspect, an example method is disclosed. The example method includes: (a) receiving a set of query fingerprints associated with a media file; (b) comparing the set of query fingerprints to a set of reference fingerprints associated with a plurality of primary reference media files stored in a primary reference library; (c) based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints; (d) based on identifying the first subset of query fingerprints, identifying at least one candidate reference media file of the plurality of primary reference media files associated with the one or more reference fingerprints in the set of reference fingerprints; (e) in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file; (f) based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and (g) transmitting an indication that the media file matches the particular reference media file of the plurality of secondary reference media files.

In another aspect, an example tangible, non-transitory computer readable medium is disclosed. The example tangible, non-transitory computer readable medium includes instructions that, when executed, cause at least one processor to perform a set of operations including: (a) receiving a set of query fingerprints associated with a media file; (b) comparing the set of query fingerprints to a set of reference fingerprints associated with a plurality of primary reference media files stored in a primary reference library; (c) based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints; (d) based on identifying the first subset of query fingerprints, identifying at least one candidate reference media file of the plurality of primary reference media files associated with the one or more reference fingerprints in the set of reference fingerprints; (e) in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file; (f) based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and (g) transmitting an indication that the media file matches the particular reference media file of the plurality of secondary reference media files.

In another aspect, an example computing system is disclosed. The example computing system includes: (a) at least one processor; and (b) tangible, non-transitory computer readable medium including instructions that, when executed, cause the at least one processor to perform a set of operations including: (a) receiving a set of query fingerprints associated with a media file; (b) comparing the set of query fingerprints to a set of reference fingerprints associated with a plurality of primary reference media files stored in a primary reference library; (c) based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints; (d) based on identifying the first subset of query fingerprints, identifying at least one candidate reference media file of the plurality of primary reference media files associated with the one or more reference fingerprints in the set of reference fingerprints; (e) in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file; (f) based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and (g) transmitting an indication that the media file matches the particular reference media file of the plurality of secondary reference media files.

### BRIEF DESCRIPTION OF THE FIGURES

FIG. 1 illustrates a simplified block diagram of an example computing device.

FIG. 2 illustrates a simplified block diagram of an example media content matching system of certain embodiments.

FIGS. 3A-C illustrate example depictions of matching and non-matching portions of versions of media content in different languages.

FIG. 4 illustrates a flow chart of an example method of certain embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

In this disclosure, unless otherwise specified and/or unless the particular context clearly dictates otherwise, the terms “a” or “an” mean at least one, and the term “the” means the at least one.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments may be utilized and other changes may be made without departing from the scope of the subject matter presented herein.

Accordingly, the example embodiments described herein are not meant to be limiting. It will be readily understood that the aspects of the present disclosure, as generally described herein, and illustrated in the figures, may be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

As used herein, “media content” and “media files” are used interchangeably and should be understood as media content contained, stored, and/or executing in a file structure, such as on a computer-readable storage medium or stream of data.

In examples, a media content matching system attempts to identify media content using a reference library for reference media files. For example, the media content may be contained in a computer file or in a stream of data. In examples, one or more fingerprints of the media content may be generated and compared to reference media fingerprints stored in a reference library. For example, the media content may be processed (for example, by a device such as a metering device associated with an audience measurement entity) to generate fingerprints and/or sub-fingerprints that include representations of the media content. In some examples, based on the comparison of the fingerprints, one or more potentially matching reference media may be identified. The media content to be identified may include video and/or audio, such as songs, television shows, and movies, for example. In some examples, the audio content of the media content is used for fingerprinting. In some examples, audio content is used for fingerprinting and matching protocols because it may be more computationally efficient (for example, as compared to video fingerprinting and matching).

In some examples, media content may have multiple versions, which may create a number of problems for fingerprinting and matching with corresponding reference media files. For example, media content may have versions that are modified to be presented in multiple different languages (for example, an English version, Spanish version, Italian version, among others) to be broadcast and/or streamed in one or more geographical regions. In some examples, the media content may be modified in other ways that affect fingerprinting and/or matching, including different portions of the media content across different version of the media content (for example, shorter title and/or recap sequences).

In some examples, media content may differ by having a portion of the audio content in different languages. For example, a movie may have versions with soundtracks that have the primary dialog in English, Spanish, or Italian and the video portion of the movie may be identical or almost identical between the versions. In examples, the soundtrack (including music, background noise, and sound effects, for example), aside from the dialog, may also be identical or almost identical between these various versions of the media content. Fingerprints generated based on identical or almost identical media are expected to be the same or very similar, for example. However, in some examples, the dialog portions of each version may result in potentially dissimilar fingerprints because of the different languages, particularly in the dialog portions of the media content. Consequently, the reference library would need to have reference fingerprints for each of these different language versions of the media content in order to correctly identify the media.

The computational, processing, and time requirements of storing these different language versions of reference media content that correspond to the same media content and then matching a query media content are enormous, and only increase in proportion to the number of reference media content supported by the reference library. Further, as new media is added to reference libraries (which may be at a rate of 2500 new programs per day (or more)), alternative language versions of the same underlying program (for example, the same television show episode or movie) also have to be fingerprinted and stored in these reference media libraries. And, as the reference library gets larger, the amount of processing and time required for matching increases in proportion. The computational burden imposed by this arrangement is computationally expensive, time consuming, and may often lead to untimely and/or inaccurate fingerprinting and/or matching protocols. Thus, there exists a need for improved fingerprinting and matching systems for multiple versions of the same media content—particularly for multiple versions of the same media content in a variety of different languages.

This disclosure describes various techniques for providing more computationally efficient, timely, and accurate matching of media content with alternative versions of the media content. More particularly, as discussed below, disclosed embodiments provide for identifying one or more potential matches using a primary reference library (for example, where all reference content stored in the primary reference library is for English language versions) and then using a subset of reference fingerprints in a secondary reference library to identify a particular matching reference media file (for example, by matching a subset of reference content that contains various language versions of the one or more potential matches stored in the secondary reference library). In some examples, the primary reference library may be a repository for media files in a particular, first language and the secondary reference library may be a repository for different version of the media files stored in the primary reference library, but in alternative language versions of the media files. The example methods, systems, and devices described herein provide for identifying media content while significantly reducing processing and latency requirements to do so as compared to other techniques.

In examples, processing and latency requirements of matching media content are generally directly proportional to the size of the reference library being used. For example, matching fingerprints for media content to be identified against a library with sets of reference fingerprints for 100,000 reference items would be expected to take significantly more processing resources, capacity, and time than when matching against a reference library with only 1000 items. As new reference media content is added, each of the requirements increases. The rate of increase is even higher when the media content has multiple alternative versions. For example, a single new movie may have soundtracks with dialog in twelve different languages, resulting in twelve new sets of reference fingerprints to support them. The increases in these requirements increases the cost associated with performing matching on each set of fingerprints to be queried against the reference library. Furthermore, in some examples, a first fingerprinting and/or matching protocol associated with a first reference library (for example, a primary reference library) may be more computationally burdensome and/or time-consuming than a second fingerprinting and/or matching protocol associated with a second reference library (for example, a secondary reference library). In some examples, the first and second fingerprinting and/or matching protocols may vary based on sample size (for example, audio sample size), buffer rate, and/or bit rate, among other factors. Thus, in examples, to reduce computational burden and expense, it may be desirable to utilize the first fingerprinting and/or matching protocol as a first pass at matching, and then use the potential matches from the first pass to narrow the set of potential matches in the first fingerprinting and/or matching protocol (for example, a second pass protocol). For example, a less computationally expensive fingerprinting and/or matching protocol may be utilized for matching against the first reference library because of its size whereas a second, potentially more computationally expensive fingerprinting and/or matching protocol may be utilized for matching against a subset of the second reference library because the subset has been significantly reduced in the number of items based on the initial matching against the first reference library.

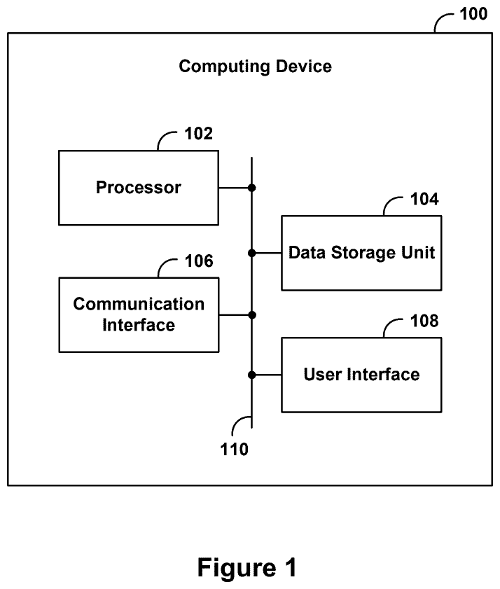

Turning to FIG. 1, FIG. 1 illustrates a simplified block diagram of an example computing device 100. Computing device 100 may perform various acts and/or functions, such as those described in this disclosure. Computing device 100 may include various components, such as processor 102, data storage unit 104, communication interface 106, and/or user interface 108. These components may be connected to each other (or to another device, system, or other entity) via connection mechanism 110.

Processor 102 may include a general-purpose processor (for example, a microprocessor) and/or a special-purpose processor (for example, a digital signal processor (“DSP”)).

Data storage unit 104 may include one or more volatile, non-volatile, removable, and/or non-removable storage components, such as magnetic, optical, or flash storage, and/or may be integrated in whole or in part with processor 102. Further, data storage unit 104 may take the form of a non-transitory computer-readable storage medium, having stored thereon program instructions (for example, compiled or non-compiled program logic and/or machine code) that, when executed by processor 102, cause computing device 100 to perform one or more acts and/or functions, such as those described in this disclosure. As such, computing device 100 may be configured to perform one or more acts and/or functions, such as those described in this disclosure. Such program instructions may define and/or be part of a discrete software application. In some instances, computing device 100 may execute program instructions in response to receiving an input, such as from communication interface 106 and/or user interface 108. Data storage unit 104 may also store other types of data, such as those types described in this disclosure.

Communication interface 106 may allow computing device 100 to connect to and/or communicate with another other entity according to one or more protocols. In one example, communication interface 106 may be a wired interface, such as an Ethernet interface or a high-definition serial-digital-interface (“HD-SDI”). In another example, communication interface 106 may be a wireless interface, such as a radio, cellular, or WI-FI® interface. In this disclosure, a connection may be a direct connection or an indirect connection, the latter being a connection that passes through and/or traverses one or more entities, such as a router, switcher, or other network device. Likewise, in this disclosure, a transmission may be a direct transmission or an indirect transmission. Further, the term “connection mechanism” as used therein refers to one or more mechanisms that facilitate communication between two or more components, devices, systems, or other entities. A connection mechanism may be a relatively simple mechanism, such as a cable or system bus, or a relatively complex mechanism, such as a packet-based communication network (for example, the Internet). In some instances, a connection mechanism may include a non-tangible medium (for example, in the case where the connection is wireless).

User interface 108 may facilitate interaction between computing device 100 and a user of computing device 100, if applicable. As such, user interface 108 may include input components such as a keyboard, a keypad, a mouse, a touch sensitive panel, a microphone, and/or a camera, and/or output components such as a display device (which, for example, may be combined with a touch sensitive panel), a sound speaker, and/or a haptic feedback system. More generally, user interface 108 may include hardware and/or software components that facilitate interaction between computing device 100 and the user of the computing device 100.

In this disclosure, the term “computing system” means a system that includes at least one computing device, such as computing device 100. A computing system and/or components thereof may perform various acts, such as those set forth below.

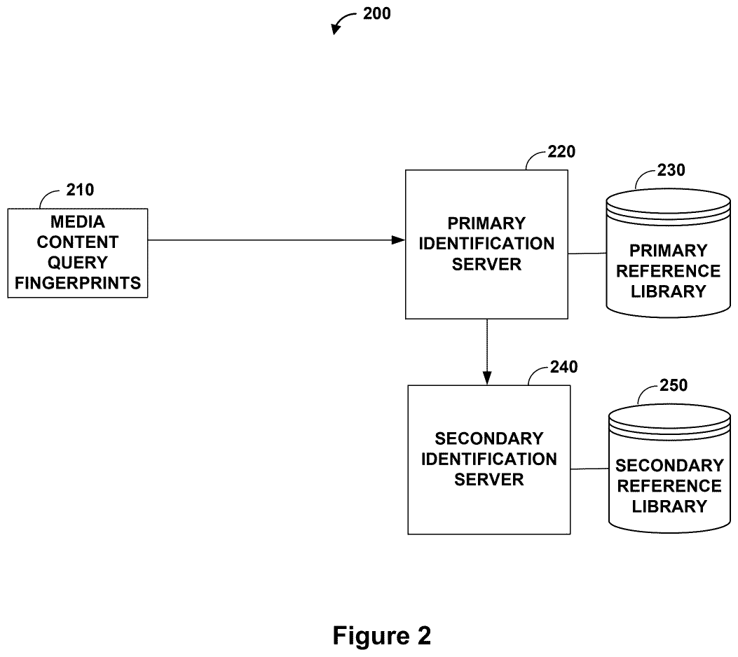

FIG. 2 illustrates a simplified block diagram of an example media content matching system 200 of certain embodiments. In an example embodiment, the media content matching system 200 includes media content query fingerprints 210, a primary identification server 220, a primary reference library 230, a secondary identification server 240, and a secondary reference library 250.

In some examples, the media content query fingerprints 210 are provided to the primary identification server 220. For example, the media content query fingerprints 210 may be provided as a query to the media content matching system 200. The media content query fingerprints 210 may be data associated with media content to be identified, such as a television show, movie, video game, or radio broadcast, for example. For example, a metering device in an audience measurement system may generate the media content query fingerprints 210 based on media content monitored by the metering device. In some examples, the metering device may transmit over a network or stream the media content query fingerprints 210 as they are generated on a real-time or near-real-time basis. In some examples, the metering device may batch generated fingerprints to be provided on a per-program, hourly (for example, every 1, 2, 4, 8, or 12 hours), or daily basis, for example. As another example, the media content query fingerprints 210 may be generated from a media file that is being considered for inclusion in a reference library, to check whether the media file is already present in the reference library. In examples, the media content query fingerprints 210 may be communicated to the primary identification server 220 over a communication interface, such as communication interface 106, for example.

In some examples, the primary identification server 220 is a computing system that includes a computing device that processes fingerprints to attempt to identify reference media content files that may be the same as the media content associated with the fingerprints. In some examples, the primary identification server 220 is in communication with the primary reference library 230. In some embodiments, the primary identification server 220 may use the primary reference library 230 to attempt to identify the media content. In some embodiments, the primary reference library 230 includes reference fingerprints associated with reference media files.

In some examples, the primary identification server 220 compares the received media content query fingerprints 210 with the reference fingerprints in the primary reference library 230. In examples, based on that comparison, the primary identification server 220 identifies a first set of matching fingerprints and a second set of non-matching fingerprints for the media content query fingerprints 210. For example, the media content query fingerprints 210 may be divided into a first subset of query fingerprints and a second subset of query fingerprints based on whether a particular media content query fingerprint satisfies a threshold extent of similarity to one or more reference fingerprints. For example, the set of matching fingerprints includes the media content query fingerprints 210 that satisfy at least a first threshold extent of similarity with a reference fingerprint in the primary reference library 230. As another example, the set of non-matching fingerprints include the media content query fingerprints 210 that do not satisfy at least a first threshold extent of similarity with a reference fingerprint in the primary reference library 230.

In some embodiments, the primary identification server 220 receives metadata associated with the media content query fingerprints 210. For example, the metadata may include a source, geographic location, language, or duration of the media content associated with the media content query fingerprints 210. In some examples, based on the metadata, the primary identification server 220 identifies a subset of the reference fingerprints in the primary reference library 230 to compare the media content query fingerprints 210 to. For example, based on a geographic location specified in the metadata, the primary identification server 220 may select or filter the primary reference library 230 for a primary language associated with that geographic location. If, for example, the geographic location indicated that the media content associated with the media content query fingerprints 210 is being received from Mexico, the primary identification server 220 may use a primary reference library 230 with a language of Spanish. As another example, the primary identification server 220 may filter the primary reference library 230 based on duration and only compare the media content query fingerprints 210 to reference fingerprints in the primary reference library 230 that are associated with reference media content with a duration within a threshold percentage of the duration specified in the metadata.

In some examples, the primary identification server 220 then identifies at least one candidate reference media file based on the set of matching fingerprints. For example, the at least one candidate reference media file may be associated with the reference fingerprints to which the fingerprints in the set of matching fingerprints had a corresponding threshold extent of similarity. The set of matching fingerprints may be considered as hints as to the correct matching reference file, for example. In examples, the at least one candidate reference media file may be identified by identifiers of the reference media files associated with the reference fingerprints to which the fingerprints in the set of matching fingerprints had a corresponding threshold extent of similarity. In some examples, the identified at least one candidate reference media file and the set of non-matching fingerprints are provided to the secondary identification server 240. For example, an identifier for the identified at least one candidate reference media file and the set of non-matching fingerprints may be communicated to the secondary identification server 240 over a communication interface, such as communication interface 106, for example. In some examples, the set of matching fingerprints is also provided to the secondary identification server 240.

In certain embodiments, the primary reference library 230 includes reference fingerprints for reference media files in a first language and does not include reference fingerprints for other versions of those reference media files that may be in other languages than the first language. For example, although a media file may have numerous versions with different primary languages, the primary reference library 230 may include reference fingerprints for only the English version of the media file.

In some examples, the secondary identification server 240 is a computing system that includes a computing device that processes fingerprints to attempt to identify media content associated the media content query fingerprints 210. In some examples, the secondary identification server 240 is in communication with the secondary reference library 250. In some embodiments, the secondary identification server 240 may use the secondary reference library 250 to attempt to identify the media content. In some embodiments, the secondary reference library 250 includes reference fingerprints associated with reference media files.

In some examples, the secondary identification server 240 determines a subset of reference fingerprints in the secondary reference library 250 based on the identified at least one candidate reference media file. For example, the subset of reference fingerprints in the secondary reference library 250 may be the reference fingerprints associated with reference media files in the secondary reference library 250 that correspond to the identified at least one candidate reference media file.

In some examples, the secondary identification server 240 compares the set of non-matching fingerprints with the subset of reference fingerprints from the secondary reference library 250. In some embodiments, based on that comparison, the secondary identification server 240 determines that a particular reference media file has at least a second threshold extent of similarity with the media content associated with the media content query fingerprints 210. In some examples, the secondary identification server 240 also compares the set of matching fingerprints with the subset of fingerprints from the secondary reference library 250. In some embodiments, based on the comparison of both the set of matching fingerprints and the set of non-matching fingerprints with the subset of reference fingerprints, the secondary identification server 240 determines that a particular reference media file has at least a second threshold extent of similarity with the media content associated with the media content query fingerprints 210.

In some examples, the secondary identification server 240 communicates an indication that the media content associated with the media content query fingerprints 210 matches the determined particular reference media file. In some embodiments, the secondary identification server 240 may communicate metadata associated with the determined particular reference media file. The metadata may include a title, a language, a release date, a broadcast date, an identifier associated with the determined particular reference media file (such as a unique identifier), an indicator of the confidence of the match, and/or cast information, for example.

In certain embodiments, the secondary reference library 250 includes reference fingerprints for reference media files in one or more languages other than the first language used in the primary reference library 230. For example, if the primary reference library 230 includes reference fingerprints associated with reference media files in English, the secondary reference library 250 may include reference fingerprints associated with alternative language versions of those reference media files in other languages, such as Spanish, French, and Italian.

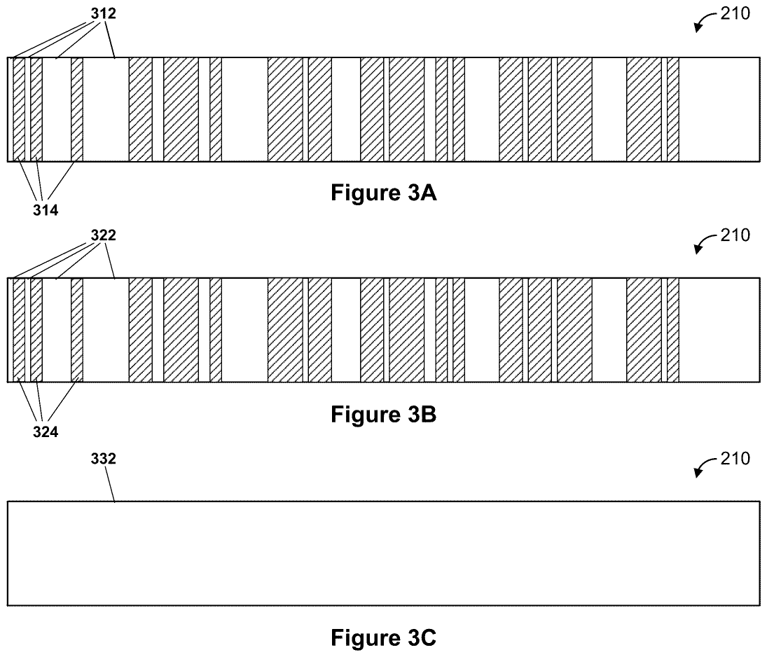

Referring now to FIGS. 3A-3C, with continuing reference to FIGS. 1-2, FIGS. 3A-3C illustrates an example depiction of matching portions 312, 322, and 332 (indicated with no shading) and non-matching portions 314 and 324 (indicated with diagonal shading) of the media content query fingerprints 210 in such a scenario. In some examples, when the media content query fingerprints 210 are for a media file in the same language as the primary reference library 230 (for example, English), then the primary identification server 220 may be able to identify a match during a first pass of matching. However, if the media content query fingerprints 210 are for a media file in a different language than the reference fingerprints associated with reference media files stored in the primary reference library 230, then only some portions of the media content query fingerprints 210 may match with reference fingerprints in the primary reference library 230. As a result, the media content query fingerprints 210 would match with some portions of the reference fingerprints in the primary reference library 230 (for example, reference fingerprints associated with an English language version of a reference media file), which would lead to the identification of at least one candidate reference media file that merits further matching analysis via a secondary identification server 240 and secondary reference library 250, for example.

In some examples, when the media content query fingerprints 210 are for a media file in a different language as the primary reference library 230, then the primary identification server 220 may identify both matching and non-matching fingerprints. The matching fingerprints may correspond to portions of the media associated with the media content query fingerprints 210 that have no dialog, for example, while the non-matching fingerprints may correspond to portions of the media associated with the media content query fingerprints 210 having dialog in a different language. For example, if the primary reference library 230 is for reference media files in English and the media content query fingerprints 210 are for a Spanish version of the program, the non-matching fingerprints may primarily be associated with the portions where characters are speaking in a different language. With continuing reference to FIGS. 1-2, FIGS. 3A-3C illustrate an example depiction of matching portions 312, 322, and 332 (indicated with no shading) and non-matching portions 314 and 324 (indicated with diagonal shading) of the media content query fingerprints 210 associated with a media item that is being presented in Spanish.

As shown in FIG. 3A, when the media content query fingerprints 210 for a media file (in Spanish) are compared with the reference fingerprints stored in the primary reference library 230 (in English), a partial match may be identified with the English language version of a reference media file (a candidate media file), but indicate that there are both matching portions 312 (non-dialog portions) and non-matching portions 314 (Spanish vs. English dialog portions). Thus, in examples, further analysis of this candidate media file may be beneficial to identify a set of fingerprints associated with a reference media file that is a more complete match with the media content query fingerprints 210 (in Spanish). To do so, in examples, further matching analysis may be conducted via a secondary identification server 240 and secondary reference library 250 that stores multiple versions (for example, multiple language versions) for the candidate media file and/or fingerprints associated with the candidate media file.

In examples, as shown in FIG. 3B, the candidate media file is used to identify reference fingerprints associated with alternative language versions of the candidate media file stored in a secondary reference library 250 and then secondary identification server 240 compares the media content query fingerprints 210 (in Spanish) to reference fingerprints associated with a first alternative language version (in Italian) stored in the secondary reference library 250. Like FIG. 3A, a partial match may be identified with the Italian language version of the candidate media file, and indicate that there are both matching portions 322 (non-dialog portions) and non-matching portions 324 (Spanish vs. Italian dialog portions). Thus, in examples, additional analysis of this candidate media file may be beneficial to identify a set of fingerprints associated with a reference media file that is a more complete match with the media content query fingerprints 210 (in Spanish). Turning to FIG. 3C, when the secondary identification server 240 compares the media content query fingerprints 210 (in Spanish) to a set of reference fingerprints for a second alternative language version (in Spanish) stored in the secondary reference library 250, unlike FIGS. 3A-3B, there are only matching portions 332 between the two sets of fingerprints (dialog and non-dialog portions, alike). Thus, in examples, additional analysis of this candidate media file may be beneficial to identify a set of reference fingerprints that is a more complete match with the media content query fingerprints 210 (in Spanish). The corresponding non-matching fingerprints in FIGS. 3A-3B are closely correlated and all three examples contain correlated matching fingerprints (suggesting that the fingerprints corresponding to FIGS. 3A-3C are for alternative language versions of the same program), but the second alternative language version analyzed in FIG. 3C is the complete match with media content query fingerprints 210.

Referring back to FIG. 2, in some embodiments, the primary identification server 220 is part of the same computing device as the secondary identification server 240.

In some embodiments, the primary reference library 230 and the secondary reference library 250 are subsets of the same database. For example, the primary identification server 220, when comparing the media content query fingerprints 210 to the reference fingerprints may identify the reference fingerprints to match against by filtering them based on the associated language. As another example, the primary reference library 230 may be a view of a larger reference library that is restricted to a single language. Likewise, the secondary identification server 240 may identify the reference fingerprints to match against by filtering them based on all languages other than the language used by the primary identification server 220. As another example, the secondary reference library 250 may be a view of a the same larger reference library used by the primary reference library 230 that is restricted to all languages except the one used by the primary reference library 230.

The structure of media content matching system 200 reduces the computational and processing requirements for matching a particular piece of media content. By having the primary identification server 220 use a primary reference library 230 that contains reference fingerprints only for a specific version of media content with multiple alternative versions (for example, just the English language versions), the primary reference library 230 is reduced in size because it does not have to contain reference fingerprints for each alternative version of each piece of media content. As a result, the matching of the media content query fingerprints 210 to identify the matching and non-matching fingerprints and the at least one candidate reference media file requires less processing and takes less time than if the primary reference library contained all alternative versions. In addition, by identifying the at least one candidate reference media file and providing it (for example, by providing an identifier for the at least one candidate reference media file(s)) to the secondary identification server 240, the secondary identification server 240 may compare the non-matching fingerprints against a much smaller subset of the alternative versions (for example, the other language versions) of the identified at least one candidate reference media content from the secondary reference library 250. As a result, the media content associated with the media content query fingerprints 210 may be identified with reduced processing and latency requirements. In some examples, as discussed above, the primary identification server 220 may filter the primary reference library 230 based on metadata associated with the media content query fingerprints 210, which may further reduce the computational and processing requirements for matching a particular piece of media content by narrowing the number of entries in the primary reference library 230 that are used for matching.

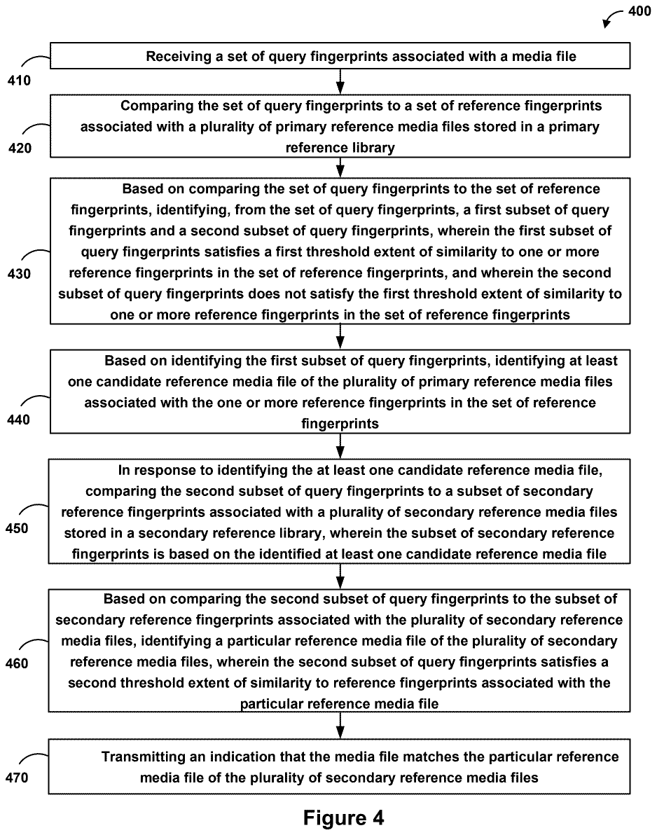

FIG. 4 illustrates a flow chart of an example method 400 of certain embodiments.

The method 400 may be a computer-implemented method, and/or may be carried out by a computing system, such as media content matching system 200, or by one or more components thereof, and/or may be carried out in response to instructions stored on a non-transitory computer-readable medium being executed by a computing device.

At block 410, the method 400 may involve receiving a set of query fingerprints associated with a media file. In some aspects, the set of query fingerprints are obtained from a metering device associated with an audience measurement entity.

At block 420, the method 400 may involve comparing the set of query fingerprints to a set of reference fingerprints associated with a plurality of primary reference media files stored in a primary reference library.

At block 430, the method 400 may involve, based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints.

At block 440, the method 400 may involve, based on identifying the first subset of query fingerprints, identifying at least one candidate reference media file of the plurality of primary reference media files associated with the one or more reference fingerprints in the set of reference fingerprints.

At block 450, the method 400 may involve, in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file. In some examples, the primary reference media files are associated with a first language and the secondary reference media files are associated with a second language.

At block 460, the method 400 may involve, based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file. In examples, the media file associated with the set of query fingerprints is considered to be matched with or identified as the identified particular reference media file based on the comparison. For example, the media file associated with the set of query fingerprints may be determined to have the same content and/or associated metadata as the particular reference media file. As another example, the media file associated with the set of query fingerprints may be determined to be the same language version as the particular reference media file. In some examples, audio content of the at least one candidate reference media file includes a first language and audio content of the particular reference media file includes a second language. In some examples, the first language and the second language are different languages.

At block 470, the method 400 may involve transmitting an indication that the media file matches the particular reference media file of the plurality of secondary reference media files. In some examples, transmitting the indication that the media file matches the particular reference media file includes transmitting metadata associated with the particular reference media file. In some examples, the metadata includes one or more of: (i) a title; (ii) a language; (iii) a date; (iv) an identifier associated with the particular reference media file; (v) a match confidence indicator; and (vi) cast information. In examples, in addition to and/or instead of transmitting the indication, an indication that the media file matches the particular reference media file may be displayed. In examples, in addition to and/or instead of transmitting the indication, media content associated with the media file is credited based on the indication that the media file matches the particular reference media file.

In some examples, the method 400 may involve determining that the at least one candidate reference media file includes an alternative language version of the particular reference media file.

In some examples, the method 400 may involve, prior to comparing the set of query fingerprints to the set of reference fingerprints associated with the plurality of primary reference media files stored in the primary reference library, identifying metadata associated with the media file, and based on the identified metadata, comparing the set of query fingerprints to a subset of the set of reference fingerprints associated with a subset of the plurality of primary reference media files stored in the primary reference library. In some examples, the metadata includes a geographic location associated with the media file. In some examples, the metadata includes a language associated with the media file.

In one aspect, a tangible, non-transitory computer readable medium including instructions that, when executed, cause at least one processor to perform a set of operations is disclosed. In examples, the set of operations includes: (i) receiving a set of query fingerprints associated with a media file; (ii) comparing the set of query fingerprints to a set of reference fingerprints associated with a plurality of primary reference media files stored in a primary reference library; (iii) based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints; (iv) based on identifying the first subset of query fingerprints, identifying at least one candidate reference media file of the plurality of primary reference media files associated with the one or more reference fingerprints in the set of reference fingerprints; (v) in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file; (vi) based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and (vii) transmitting an indication that the media file matches the particular reference media file of the plurality of secondary reference media files.

In one aspect, a computing system including at least one processor and a tangible, non-transitory computer readable medium including instructions that, when executed, cause the at least one processor to perform a set of operations is disclosed. In examples, the set of operations includes: (i) receiving a set of query fingerprints associated with a media file; (ii) comparing the set of query fingerprints to a set of reference fingerprints associated with a plurality of primary reference media files stored in a primary reference library; (iii) based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints; (iv) based on identifying the first subset of query fingerprints, identifying at least one candidate reference media file of the plurality of primary reference media files associated with the one or more reference fingerprints in the set of reference fingerprints; (v) in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file; (vi) based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and (vii) transmitting an indication that the media file matches the particular reference media file of the plurality of secondary reference media files.

The present disclosure is not to be limited in terms of the particular embodiments described in this application, which are intended as illustrations of various aspects. Many modifications and variations may be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments may be utilized, and other changes may be made, without departing from the scope of the subject matter presented herein. It will be readily understood that the aspects of the present disclosure, as generally described herein, and illustrated in the figures, may be arranged, substituted, combined, separated, and designed in a wide variety of different configurations.

With respect to any or all of the message flow diagrams, scenarios, and flow charts in the figures and as discussed herein, each step, block, and/or communication may represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages may be executed out of order from that shown or discussed, including substantially concurrently or in reverse order, depending on the functionality involved. Further, more or fewer blocks and/or operations may be used with any of the message flow diagrams, scenarios, and flow charts discussed herein, and these message flow diagrams, scenarios, and flow charts may be combined with one another, in part or in whole.

A step or block that represents a processing of information may correspond to circuitry that may be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including RAM, a disk drive, a solid-state drive, or another storage medium.

The computer readable medium may also include non-transitory computer readable media such as non-transitory computer readable media that store data for short periods of time like register memory and processor cache. The non-transitory computer readable media may further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media may also be any other volatile or non-volatile storage systems. A non-transitory computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments could include more or less of each element shown in a given figure. Further, some of the illustrated elements may be combined or omitted. Yet further, an example embodiment may include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a set of query fingerprints associated with a media file;
comparing the set of query fingerprints to a set of reference fingerprints associated with a plurality of primary reference media files stored in a primary reference library;
based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints;
based on identifying the first subset of query fingerprints, identifying at least one candidate reference media file of the plurality of primary reference media files associated with the one or more reference fingerprints in the set of reference fingerprints;
in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file;
based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and
transmitting an indication that the media file matches the particular reference media file of the plurality of secondary reference media files.

2. The method of claim 1, wherein the primary reference media files are associated with a first language and the secondary reference media files are associated with a second language.

3. The method of claim 1, wherein audio content of the at least one candidate reference media file comprises a first language and audio content of the particular reference media file comprises a second language.

4. The method of claim 3, wherein the first language and the second language are different languages.

5. The method of claim 3, further comprising determining that the at least one candidate reference media file comprises an alternative language version of the particular reference media file.

6. The method of claim 1, wherein transmitting the indication that the media file matches the particular reference media file comprises transmitting metadata associated with the particular reference media file.

7. The method of claim 6, wherein the metadata comprises one or more of: (i) a title; (ii) a language; (iii) a date; (iv) an identifier associated with the particular reference media file; (v) a match confidence indicator; and (vi) cast information.

8. The method of claim 1, further comprising, prior to comparing the set of query fingerprints to the set of reference fingerprints associated with the plurality of primary reference media files stored in the primary reference library, identifying metadata associated with the media file, and based on the identified metadata, comparing the set of query fingerprints to a subset of the set of reference fingerprints associated with a subset of the plurality of primary reference media files stored in the primary reference library.

9. The method of claim 8, wherein the metadata comprises a geographic location associated with the media file.

10. The method of claim 8, wherein the metadata comprises a language associated with the media file.

11. A tangible, non-transitory computer readable medium comprising instructions that, when executed, cause at least one processor to perform a set of operations comprising:
receiving a set of query fingerprints associated with a media file;
comparing the set of query fingerprints to a set of reference fingerprints associated with a plurality of primary reference media files stored in a primary reference library;
based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints;
based on identifying the first subset of query fingerprints, identifying at least one candidate reference media file of the plurality of primary reference media files associated with the one or more reference fingerprints in the set of reference fingerprints;
in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file;
based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and
transmitting an indication that the media file matches the particular reference media file of the plurality of secondary reference media files.

12. The tangible, non-transitory computer readable medium of claim 11, wherein the primary reference media files are associated with a first language and the secondary reference media files are associated with a second language.

13. The tangible, non-transitory computer readable medium of claim 11, wherein audio content of the at least one candidate reference media file comprises a first language and audio content of the particular reference media file comprises a second language.

14. The tangible, non-transitory computer readable medium of claim 13, wherein the first language and the second language are different languages.

15. The tangible, non-transitory computer readable medium of claim 13, further comprising determining that the at least one candidate reference media file comprises an alternative language version of the particular reference media file.

16. The tangible, non-transitory computer readable medium of claim 11, wherein transmitting the indication that the media file matches the particular reference media file comprises transmitting metadata associated with the particular reference media file.

17. The tangible, non-transitory computer readable medium of claim 11, further comprising, prior to comparing the set of query fingerprints to the set of reference fingerprints associated with the plurality of primary reference media files stored in the primary reference library, identifying metadata associated with the media file, and based on the identified metadata, comparing the set of query fingerprints to a subset of the set of reference fingerprints associated with a subset of the plurality of primary reference media files stored in the primary reference library.

18. The tangible, non-transitory computer readable medium of claim 17, wherein the metadata comprises a geographic location associated with the media file.

19. The tangible, non-transitory computer readable medium of claim 17, wherein the metadata comprises a language associated with the media file.

20. A computing system comprising:
at least one processor; and
tangible, non-transitory computer readable medium comprising instructions that, when executed, cause the at least one processor to perform a set of operations comprising:
receiving a set of query fingerprints associated with a media file;
comparing the set of query fingerprints to a set of reference fingerprints associated with a plurality of primary reference media files stored in a primary reference library;
based on comparing the set of query fingerprints to the set of reference fingerprints, identifying, from the set of query fingerprints, a first subset of query fingerprints and a second subset of query fingerprints, wherein the first subset of query fingerprints satisfies a first threshold extent of similarity to one or more reference fingerprints in the set of reference fingerprints, and wherein the second subset of query fingerprints does not satisfy the first threshold extent of similarity to one or more reference fingerprints in the set of reference fingerprints;
based on identifying the first subset of query fingerprints, identifying at least one candidate reference media file of the plurality of primary reference media files associated with the one or more reference fingerprints in the set of reference fingerprints;
in response to identifying the at least one candidate reference media file, comparing the second subset of query fingerprints to a subset of secondary reference fingerprints associated with a plurality of secondary reference media files stored in a secondary reference library, wherein the subset of secondary reference fingerprints is based on the identified at least one candidate reference media file;
based on comparing the second subset of query fingerprints to the subset of secondary reference fingerprints associated with the plurality of secondary reference media files, identifying a particular reference media file of the plurality of secondary reference media files, wherein the second subset of query fingerprints satisfies a second threshold extent of similarity to reference fingerprints associated with the particular reference media file; and
transmitting an indication that the media file matches the particular reference media file of the plurality of secondary reference media files.
